(19) United States
(12) Patent Application Publication
(10) Pub. No.: US 2022/0168603 A1
(43) Pub. Date: Jun. 2, 2022

(54) COMPACT COOLING AND EXTINGUISHING SYSTEM

(71) Applicant: ASES GROUP, s.r.o., Praha 4, Krc (CZ)

(72) Inventors: Marek Duda, Praha (CZ); Peter RONCAK, Praha (CZ)

(73) Assignee: ASES GROUP, s.r.o., Praha 4, Krc (CZ)

(21) Appl. No.: 17/437,406

(22) PCT Filed: Mar. 11, 2020
(86) PCT No.: PCT/CZ2020/000011

§ 371 Date: Sep. 8, 2021

(30) Foreign Application Priority Data
Mar. 13, 2019 (CZ) PV 2019-145

(51) Int. Cl. A62C 37/40; A62C 3/16; A62C 37/50

(52) U.S. Cl. CPC A62C 37/40; A62C 37/50; A62C 3/16

(57) ABSTRACT

The compact cooling and extinguishing system is designed to be arranged in a protected device, in particular electrical switchboards with a DIN rail, wherein the compact automatic cooling and extinguishing system consists of a carrier (14) containing inside a pressurized cooling and extinguishing medium, wherein the medium is based on chemical extinguishing agents, which are characterized in that during initiation their temperature, when escaping the carrier, is in negative values, i.e. temperature below 0° C., below the freezing reference point, the system is further provided with a pressure indicator for monitoring the condition of the cooling and extinguishing medium, wherein the compact cooling and extinguishing system is further provided with a first temperature, pressure or smoke switch (15) and a valve (5), which is connected to the carrier of the cooling and extinguishing medium by connection (18), wherein the valve is further provided with a nozzle (6) for release of the cooling and extinguishing medium into the space of the protected device and the valve (6) is further connected to the relay (7). The system is provided with an external power supply (13). The first switch (4) is set to open the valve (5) when the given temperature value is reached in the protected device. In a preferred embodiment, the compact cooling and extinguishing system is provided with a compact cover (2) for mounting on a DIN rail.

### FIELD OF THE INVENTION

The invention relates to a compact cooling and extinguishing system which automatically monitors and suppresses undesirable thermal effects in protected devices, in particular in electrical switchboards. It is even able to cool the thermally stressed semi-enclosed or enclosed space, prevent smoke or extinguish a fire.

### BACKGROUND OF THE INVENTION

In many protected devices, such as electrical switchboards and the like, undesirable thermal effects can occur, the negative effect of which can lead to a gradual loss of functionality or destruction of these devices and, in extreme cases, to a fire. This can be caused by various processes, such as undesired chemical reactions, electrical short circuits, system overheating, occurrence of arcing, ignition of operating fluids and the like.

An automatic cooling and extinguishing system is known from CZ PV 2018-438, designed to be arranged in the protected device, such as electrical switchboard, and which consists of spatial polymer carrier containing inside the pressurized cooling and extinguishing medium. The medium is based on chemical extinguishing agents, wherein the cooling effect of the medium is used, which is characterized in that during initiation their temperature, when released from the carrier, is in negative values, i.e. temperature below 0° C., i.e. below the reference freezing point.

The medium carrier is adapted to its desired breach at increasing temperature in the protected device, starting from 30° C., when the medium is released from the broken carrier, cools the interior of the protected device and thus fire nor damage to the protected device do not occur. While the medium still retains its extinguishing effects in cases when a thermal deformation occurs that immediately becomes a fire.

However, the disadvantage of this system is that the media carrier is broken upon initiation and a new automatic cooling and extinguishing system must be installed in the protected device. The disadvantage of some solutions is the relatively complicated assembly in the protected device and the associated high cost of assembly and repairs.

### SUMMARY OF THE INVENTION

The above disadvantages of the state of the art are removed by the compact cooling and extinguishing system designed to be arranged in a protected device, in particular electrical switchboards with a DIN rail, wherein the compact automatic cooling and extinguishing system consists of a carrier containing inside a pressurized cooling and extinguishing medium, wherein the medium is based on chemical extinguishing agents, which are characterized in that during initiation their temperature, when releases from the carrier, is in negative values, i.e. temperature below 0° C., below the freezing reference point, the system is further provided with a pressure indicator for monitoring the condition of the cooling and extinguishing medium, wherein the compact cooling and extinguishing system is based on it being further provided with a first temperature, pressure or smoke switch and a valve, which is connected to the carrier of the cooling and extinguishing medium by connection, wherein the valve is further provided with a nozzle for release of the cooling and extinguishing medium and further connected to the relay. The system is provided with an independent power supply with outputs on accessible terminal boxes.

The temperature switch is set to open the valve when the given temperature value is reached in the protected device. The first switch may also be ionic, smoke, pressure or optical, analogue or digital, with or without control, etc. The conditions for opening the valve are set depending on the type of switch used. For example, the valve may be electromagnetic or mechanical with a servomotor, etc.

The compact cooling and extinguishing system is further equipped with a safety sensor, which can be ionizing, smoke, optical, laser, temperature or pressure, etc., analogue, digital, with or without control.

System connected to an external switch, which can be ionizing, smoke, optical, laser, temperature or pressure, etc., analogue, digital, with or without regulation. System connected to an external power supply. System connected to components in the electrical switchboard.

In a preferred embodiment, the compact cooling and extinguishing system is provided with a compact cover for mounting on a DIN rail. The carrier of the cooling and extinguishing medium may be metal, plastic, alloy, glass fiber, etc. The pressure indicator of the cooling and extinguishing system may be mechanical/digital, analog/digital. The system is provided with a second switch/sensor 16 and fuse 17.

The sensor or sensors for monitoring and evaluating the thermodynamic state of the medium are located directly within the medium—internal sensor, or in direct contact with the carrier of the cooling and extinguishing medium—external sensor.

The compact cooling and extinguishing system is designed for monitoring, evaluation and control the thermal process in the space of the protected device.

When the temperature in the monitored space of the protected device increases, the first sensor closes the contacts for triggering the electrical valve, when cooling and extinguishing medium is released through the nozzle into the protected device space.

The output of the first sensor may be used to eliminate the causes of the temperature increase directly, or as a signal for further processing in electronic signaling or control units. The compact cooling and extinguishing system is effective already from 30° C. The protected devices in various applications have usually higher critical temperatures. Use of this cooling property while maintaining the extinguishing capability of the medium, eliminates primarily any further temperature increase, thus creating time to address the critical situation. Release of the cooling and extinguishing medium does not pose a health hazard nor does it affect the functionality of the protected devices.

The schematic shows the compact cooling and extinguishing system connected to a battery, to which a thermostat and coils for the valve and relay are connected.

If the temperature in the protected device rises to the value to which the first switch is set, the switch closes. This opens the valve nozzle and closes the relay contact at the same time. The cooling and extinguishing medium enters the protected device through the nozzle, and at the same time, closing the relay contact brings a pulse to, for example, a RCD of the protected device which is connected to the cooling and extinguishing system. Preferably, an external switch may be connected to the system. It is further connected to an external power supply. The whole system contains several protection mechanisms. The first switch is preferably wired so that in the event of a failure of power, the first switch or the valve, the RCD of the protected device is disconnected when the set temperature of the first sensor is reached. The compact cooling and extinguishing system is designed to prevent undesired leak of the media, it operates very reliably, and may also be used for protected live devices or in other hazardous areas. Even in the event of a power outage or loss of power to the protected device, the compact cooling and extinguishing system operates at least as an emergency passive fire extinguishing system. The system is capable to be initiated even at lower temperatures than the known fire extinguishing systems, which allows for earlier intervention and elimination of damage even in the event of initial thermal destruction of the system.

In another preferred embodiment, the compact cooling and extinguishing system is connected to the systems for disconnection of the power supply of the protected device.

In another preferred embodiment, the compact cooling and extinguishing system is connected to the control systems of the protected device.

In another preferred embodiment, the compact cooling and extinguishing system is connected to the electronic signaling systems of the protected device.

In another preferred embodiment, the transfer of signals between the compact cooling and extinguishing system and the control or the electronic signaling systems of the protected device is wireless.

The system is primarily active, provided with its own power supply. In passive mode, the device provides functionality even in the case of failure of the internal electronics, for this case, it includes safety mechanisms.

Passive design—in this case, the system is primarily intended for extinguishing a fire that occurred very quickly and when it was not possible to eliminate the thermal deformation of the protected device only by the cooling function of the system. For the passive design option, it is advisable to use a pressure sensor in the form of a pressure switch, which allows indicating to the operator or to the master system the initiation or malfunction and the need for intervention such as additional extinguishing, replacement of used or damaged system.

The active design also includes monitoring and environmental conditions of the protected device, evaluating its current parameters that may affect the system effect and optimizing the initiation process as necessary, by, for example, initiating the system initiation before the set thermodynamic parameters of the system, using an additional element that modifies the thermodynamic conditions in the system towards its desired initiation.

The active system will also allow early warning of the occurrence of undesired thermal phenomena, which may prevent overheating of the system, spreading of deformation and destruction phenomena, prevent fire by early warning of the operator or disconnecting the monitored protected device from power sources, or prevent the occurrence of secondary undesired phenomenon.

### CLARIFICATION OF DRAWINGS

The invention is further clarified on the attached drawings, where

FIG. 1 illustrates schematically the compact cooling and extinguishing system and

FIG. 2 illustrates schematically the connection of the compact cooling and extinguishing system in the electrical switchboard.

### EXAMPLE EMBODIMENT OF THE INVENTION

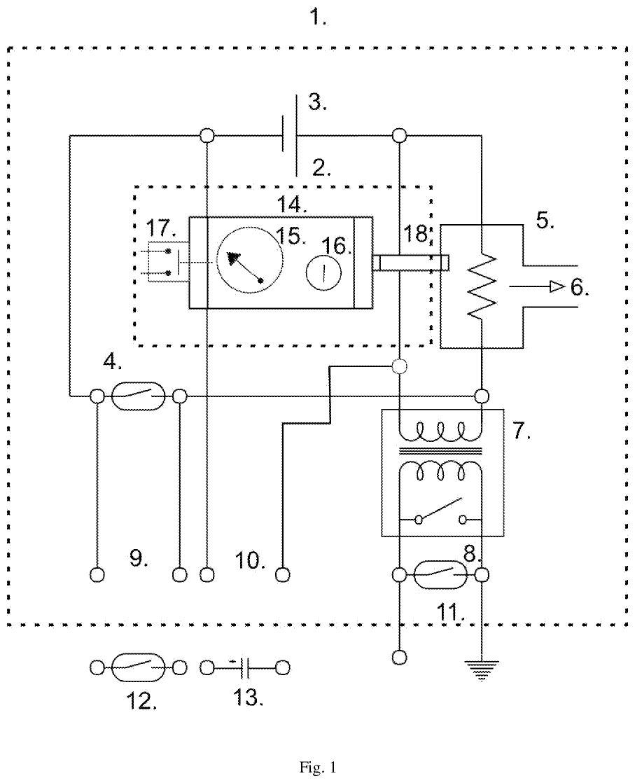

The schematic in FIG. 1 shows the compact cooling and extinguishing system connected with a battery 3, to which the first switch 4 and coils for the valve 5 and relay 7 are connected. If the temperature in the protected device rises to the value at which the first switch 4 is set, the switch closes. This opens the nozzle 6 of valve 5 and closes the relay 7 contact at the same time. The cooling and extinguishing medium enters the protected device—electrical switchboard—through the nozzle 6, and at the same time, closing the contact of relay 7 brings a pulse to, for example, the RCD 21 of the protected device which is connected to the cooling and extinguishing system. Preferably, an external switch 12 that may also trigger the initiation may be connected to the cooling and extinguishing system.

Furthermore, the system is connected to an external power supply 13. The compact cooling and extinguishing system contains a safety switch 8, fuse 17. The safety switch 8 is preferably wired so that in the event of a failure of battery 3, switch 4 or the valve 6, when the set temperature of the safety switch 8 is reached, the RCD 21 of the protected device—electrical switchboard—is disconnected.

The pressure indicator 15 allows determining visually the condition of the extinguishing medium. The first switch 4 may be preferably routed outside the compact cooling and extinguishing system, and connected to the electronic fire signaling system or other alarm systems. The carrier 14 of the cooling and extinguishing medium is directly mechanically linked to the valve 5. Thy system contains a fuse 17 in the form of plastic plug. If all electronic elements fail, the high temperatures cause burn-through this plastic plug 17, the pressurized cooling and extinguishing medium is released, thus cooling and extinguishing the fire. Another fuse is in the form of a rubber seal, which also releases the cooling and extinguishing medium into the protected device due to high temperatures.

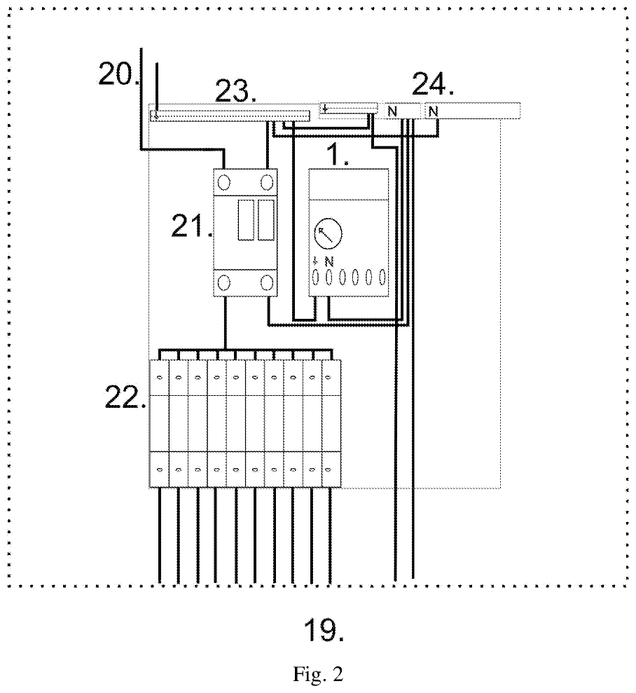

FIG. 2 illustrates schematically the wiring of the compact cooling and extinguishing system in an electrical switchboard 19 and its connection to the RCD 21, connected to the mains lead 20 and other circuit breakers 22.

The advantage of the system is in the connection of the compact cooling and extinguishing system with a RCD 21, which prevents further development of fire and smoke through disconnection of the power. Preferably, also an external switch 12 and external power supply 13 may be connected. Its compact size allows for its direct installation on a DIN rail. The installation of the RCB 21 is mandatory for all new or refurbished electrical switchboards, pursuant to the relevant standards. Any analog or digital thermostat, which is factory-set to temperatures from 30 to 150° C., may also be integrated into the system, also with the possibility of control. This extends the possibilities of deployment also to electrical switchboards 19 in refrigerated, air-conditioned or tropical climate environments.

### Industrial Use

The design of the compact cooling and extinguishing system according to the invention can be used for monitoring and suppression of undesirable thermal effects occurring in technical and technological devices, in particular in electrical switchboards, whereby the system has the ability to both cool the protected device and extinguish any fire occurring in such devices when critical limits are exceeded.

1. A compact cooling and extinguishing system (1) designed to be arranged in a protected device, the compact cooling and extinguishing system (1) comprising:
a carrier containing inside a pressurized cooling and extinguishing medium including an indicator for monitoring the condition of the cooling and extinguishing medium, a battery (3) which is connected to a first pressure, temperature or smoke switch (4), which is connected to a valve (5) wherein the valve (5) is mechanically connected to a carrier (14) by a connection (18), wherein the valve (5) is further provided with a nozzle (6) and the valve (5) is further connected to a relay (7), which is connected to a RCD (21) of a protected device, wherein the compact cooling and extinguishing system (1) is further provided with a compact cover (2) for mounting on a DIN rail.

2. with a safety switch (8) The compact cooling and extinguishing system as set forth in claim 1, including a second switch/sensor (16).

3. The compact cooling and extinguishing system as set forth in claim 1, including a carrier (14) of the cooling and extinguishing medium is made of metal or plastic or alloy or fiber or glass.

4. The compact cooling and extinguishing system as set forth in claim 1, including a safety switch (8).

5. The compact cooling and extinguishing system as set forth in claim 1, including an external switch (12).

6. The compact cooling and extinguishing system as set forth in claim 1, including an external power supply (13).

7. The compact cooling and extinguishing system as set forth in claim 1, including a fuse (17).
